(19) United States
(12) Patent Application Publication
(10) Pub. No.: US 2006/0279532 A1
(43) Pub. Date: Dec. 14, 2006

(54) Data input device controlled by motions of hands and fingers

(76) Inventors: Piotr Szczesny Olszewski, Singapore (SG); Andrzej Stefan Sluzek, Singapore (SG)

Correspondence Address: Piotr Olszewski;School of Civil & Environmental Eng., Nanyang Technological University, 50 Nanyang Avenue, Singapore, 639798, SG

(21) Appl. No.: 11/151,130

(22) Filed: Jun. 14, 2005

(51) Int. Cl. G09G 5/00

(52) U.S. Cl. 345/156

(57) ABSTRACT

A system for manual data input into computers, mobile phones or other electronic devices comprising a display device (70) and two pointing devices (60L, 60R) each equipped with a cluster of up to five finger-activated sensors (63). The display device presents a subset of characters from an alphabet and two rigid cursor patterns (40L, 40R) with up to five individual cursors representing operator's fingers. An operator uses motions of hands or thumbs to position the cursor patterns over the characters to be input and inputs them by using the finger-activated sensors. The system combines the functions of a keyboard and a pointing device and allows for data input utilizing all the fingers of operator's hands while looking only at the display device.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

The present invention is related to a system for manual data input into computers or other electronic devices and more specifically to a system involving entering characters from an available set of characters by employing motions of hands and fingers.

### BACKGROUND OF THE INVENTION—PRIOR ART

Data entered manually into computers and other similar devices consists of a stream of codes which either represent actual characters or control and editing commands. Two methods are typically used to enter such data. First, the data input can be accomplished by means of various conventional keyboards. A second type of data input, applicable mostly to devices equipped with screens or similar displays, consists of signals used for controlling the position of a cursor on a display and for entering characters currently selected by a cursor. This type of data input is achieved with a pointing device such as mouse, joystick, trackball, etc.

There are several major disadvantages of conventional keyboards:
The main limitation of a standard keyboard, regardless of its key arrangement, is that it represents a fixed predetermined character set. To accommodate new characters or editing/control functions, either combinations of existing keys should be used or new keys should be added. The former is inconvenient and very unnatural for use with languages using non-Roman alphabets such as Chinese, Japanese, etc. The latter requires modifications to be made when the keyboard is used with languages having characters not present in the character set originally used in the keyboard.
To use the keyboard, an operator has to move hands over the keys and sequentially select keys to strike. Although all ten digits are used by experienced operators, most people make use only of their index fingers and thumbs. As a result, typing involves considerable undue strain and high typing speeds are difficult to achieve.
To use conventional keyboards with larger displays, one needs to look alternately down at the keyboard and up at the display (or typed text). Again, experienced typists can memorize the location of frequently used keys and type without looking at the keys, but even they have to look before using the special character keys or combinations of keys.
Miniaturization of conventional keyboards is hard to achieve.

Since the conventional QWERTY keyboard was invented in 1878 by Sholes (U.S. Pat. No. 207,559), there have been numerous attempts both to improve the QWERTY layout and to reduce strain experienced by operators. Dvorak in 1937 (U.S. Pat. No. 2,040,248) and Gardner in 1985 (U.S. Pat. No. 4,519,721) proposed alternative improved letter arrangements for a single-cluster keyboard. Several patents advocate separation of keys into two distinct clusters to be operated by the left and right hands (U.S. Pat. No. 3,305,062 to Kittredge and U.S. Pat. No. 3,945,482 to Einbinder). In 1985 Schmidt (U.S. Pat. No. 4,522,518) proposed separation of left and right hand key clusters by an auxiliary matrix of numerical keys. In order to reduce muscle tensions experienced by operators, a concept of split keyboard having separate left and right hand units was put forward by McCall in 1983 (U.S. Pat. No. 4,378,553), and further developed by several practitioners, e.g. Lahr in 1987 (U.S. Pat. No. 4,661,005), Fort in 1995-97 (U.S. Pat. Nos. 5,393,150 and 5,662,422), Louis in 2002 (U.S. Pat. No. 6,379,060), etc.

One attempt to provide a more flexible data entry system, resulted in proposal of a reconfigurable keyboard (U.S. Pat. No. 4,688,020 to Kuehneman in 1987) in which the function of each of the keys is controlled by a computer. An example of a flexible system in which more characters can be entered than the number of keys present, is depicted in U.S. Pat. No. 4,680,728 (Davis et al., 1987). The proposed method of data entry involves a combination of strokes of keys belonging to two clusters, with the first key selecting a group of characters and the second key selecting a character within the group. A method of generating characters belonging to any character set by simultaneously touching two input devices from two sets of nine devices is proposed in U.S. Pat. No. 4,724,423 (Kinoshita, 1988). Various methods and means of keyboard reconfigurability are also proposed by other practitioners, e.g. Menn in 1986 (U.S. Pat. No. 4,633,227), Rubenson et al. in 2003 (U.S. Pat. No. 6,510,048).

None of the above mentioned prior arts solves the two fundamental problems associated with the keyboard method of data entry: (1) the need to constantly move fingers from key to key in order to choose different characters, and (2) the need to direct operator's vision at the keyboard, at least from time to time.

The second type of data input involving cursor position control, is typically accomplished with a mouse. Two basic types of mice are known, differing in the kind of movement detector device used. A mechanical mouse was developed by Engelbart in 1970 (U.S. Pat. No. 3,541,541). Two examples of electronic mice with optical movement detectors were developed by Kirsch in 1983 (U.S. Pat. No. 4,390,873) and Kato in 1987 (U.S. Pat. No. 4,647,771). Other practitioners proposed further improvements in either the mouse functionality (e.g. U.S. Pat. No. 5,765,795 to Alex in 1998) or physical embodiment (e.g. U.S. Pat. No. 6,040,821 to Franz et al. in 2000) by did not change the principles of operation.

A mouse can be used as an input device where the cursor position selects a character and pressing the button enters said selected character. This method, however, is ineffective and slow. Therefore, a mouse is typically used together with a keyboard. The main problem with using a keyboard and a mouse at the same time is the need to switch back and forth from one device to the other. This causes considerable distraction as the methods of operating the two devices are quite different.

Numerous practitioners have proposed various methods and the corresponding physical embodiments aiming to eliminate the disadvantages of a conventional keyboard and a mouse, as outlined above. In most of the attempts, conventional keyboards were replaced by a virtual keyboard pattern on the computer screen, or another display device, while the character selection was done by using motion of a pointing device (e.g. U.S. Pat. Nos. 5,008,847 and 5,058,046 to Lapeyre in 1991, U.S. Pat. No. 5,457,454 to Sugano in 1995, U.S. Pat. No. 6,104,384 to Moon et al. in 2000). Alternatively, in U.S. Pat. No. 6,614,422 to Raffi et al. in 2003, the actual strokes of fingers in relation to where keys would be on an actual keyboard are identified and displayed on an image of a keyboard. Vance et al. (U.S. Pat. No. 6,304,840, 16 Oct. 2001) have proposed a glove with multiple sensors. Characters can be entered when touching a rigid surface with fingers. The selection of the row is done be bending a finger while the column selection is achieved by changing orientation of fingers and/or hand. This configuration enables interacting with a virtual keyboard having multiple rows and columns of keys. Another device employing finger bending and wrist movement to select a character from a predefined table has been proposed by Shen (U.S. Pat. No. 6,848,083, 25 Jan. 2005).

Other practitioners have suggested other alternative methods of using individual fingers to enter characters into a computer system. For example, Dolenc in 1989 (U.S. Pat. No. 4,849,732) and Stucki in 1990 (U.S. Pat. No. 4,897,649) both propose devices in which multiple keys or sensors are provided for each finger of operator's hand or hands. Reid in 2001 (U.S. Pat. No. 6,333,734) proposes elongated keys for individual fingers where position of a finger within a key selects the row while the column is selected by pivoting the device. Rasanen (U.S. Pat. No. 6,542,091, 1 Apr. 2003) uses combinations of finger strokes to select desired characters or functions.

From the above survey of prior arts, it can be concluded that the existing systems and methods still impose limitations on functionality of manual data input devices and significant disadvantages for practical implementation. It would therefore be highly desirable to further propose a novel method and hardware apparatus with particular technological innovations for data input methods and means. This will lead towards an improvement of the overall system operation efficiency and productivity for computer systems, mobile telephony, wireless digital communication, control systems, and/or related industries.

### BACKGROUND OF THE INVENTION—OBJECTS AND ADVANTAGES

It is an object of the present invention to overcome the limitations and disadvantages of the prior art by defining a novel method of data input by using motions of hands (or alternative substitutes of motions of hands) to select a group of characters available for entering, and using actions of individual fingers to enter characters from that group of characters.

It is further an object of the present invention to generalize the proposed method of data input by including scripts of human and artificial languages, numerical data, text editing symbols, control characters, and symbols representing specific commands.

It is still further an object of the present invention to define an improved data input apparatus for the proposed method of data input.

It is still further an object of the present invention to show how the proposed data input method and apparatus can be used for a broad range of applications.

The invention disclosed herein has several important advantages over the prior art:
It is suitable for use with any language and any alphabet, including those alphabets with very large numbers of characters.
It can be quickly reconfigured for another alphabet or character set.
It eliminates the need for an operator to move fingers between keys.
It eliminates the need for an operator to look alternatively at the display and at the keys.
It is efficient by utilizing all the digits of operator's hand or hands.
It combines the functions of a keyboard and a pointing device.

### SUMMARY

The present invention disclosed herein applies a novel method and apparatus for manually entering data consisting of a stream of characters (letters). In the proposed embodiments of the method, a set of characters (referred to as an alphabet) is represented as an array of letters arranged according to rules allowing convenient localization of these letters by an operator. If data are entered using only one hand, one display area is presented to the operator. Depending on the size and/or resolution of the display area, and depending on the number of letters in the alphabet, the display area presents to the operator either the whole alphabet or a selected subset of the alphabet. If data are entered using both hands, either one or two display areas are presented. If two display areas are used, the contents presented to the operator in both display areas are not necessarily related. In particular, at any time each display area may present letters of a different alphabet or a different subset of letters from the same alphabet.

Within the display area a rigid cursor pattern is displayed with individual cursors pointing to individual letters being displayed. The number of cursors within the cursor pattern corresponds to the number of fingers the operator wishes to use for entering data, with each finger assigned (permanently or logically) to one cursor. Therefore, the current location of the cursor pattern within the display area determines which letters are currently available for entering, and the finger-to-cursor assignment determines which finger should be used to enter any of the currently available letters. If the operator enters characters using two hands and two display areas are available, each of the display areas presents one of the cursor patterns corresponding to one hand of the operator. If the operator uses two hands and only one display area is available, two cursor patterns are independently displayed within the same display area.

The location of the cursor pattern within the display area can be changed by motions of the corresponding hand, with such motions detected by a movement detection device. Therefore, the hand motions change the set of letters that are currently available for entering. Alternatively, a substitute of hand motions can be used, for example motions of a thumb (if the thumb is not one of the fingers used in the cursor pattern). Additionally, if the display area presents only a part of the alphabet, the content of the display area (i.e. the subset of letters currently displayed) can be changed by scrolling within the array of letters (representing the whole alphabet) that is also controlled by motions of the corresponding hand (or its substitute, as explained above) detected by the movement detection device.

### DRAWINGS—FIGURES

The accompanying drawings illustrate exemplary embodiments of the invention and serve to explain the principles of the invention. The drawings which are incorporated into and constitute a part of the description of the present invention, are given by way of illustration only, and thus are not limitative of the present invention.

FIG. 1 illustrates a general concept of the preferred embodiment of the present invention.

FIG. 2 is a general block diagram illustrating an exemplary two-dimensional arrangement of an alphabet array in the preferred embodiment of the present invention.

FIG. 3 is a general block diagram explaining the concept of positioning a rigid cursor pattern within a display area.

FIG. 4 is a general block diagram illustrating an exemplary one-dimensional arrangement of the alphabet array in alternative embodiments of the present invention.

FIG. 5 is a general block diagram illustrating an exemplary three-dimensional arrangement of the alphabet array in alternative embodiments of the present invention.

FIGS. 6, 7 and 8 illustrate general concepts of alternative embodiments of the present invention.

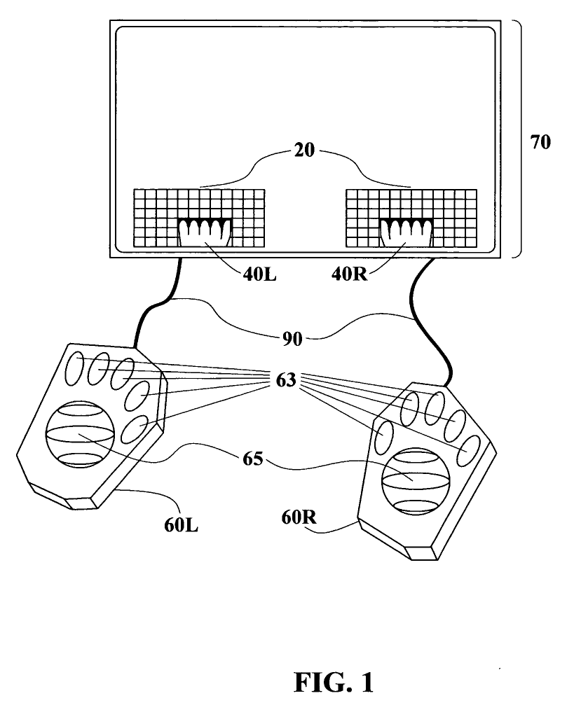

### DETAILED DESCRIPTION—PREFERRED EMBODIMENT—FIGS. 1 TO 3

In FIG. 1, the preferred embodiment of the present invention is presented. As the main components, the preferred embodiment contains two pointing devices 60L and 60R, each equipped with up to five finger-activated sensors 63 and a movement detection device 65. In the preferred embodiment finger activated-sensors 63 are in the form of pressure-sensitive switches. However, other types of sensors, such as capacitance switches, proximity-sensitive switches, etc., can also be used. Each of two movement detection devices 65 shown in FIG. 1 is a standard device used in computer mouse and comprises a trackball with coordinate encoders (details not shown). However, other devices with a similar function such as accelerometers, wireless position detectors, etc., can be used instead. Pointing devices 60L and 60R are operationally connected (using operational links 90) to a display device 70 that is a monitor, a digital display, a pattern projected on a suitable surface or any other display device working on similar principles. Operational link 90 can be accomplished with an electrical cable, an infrared or radio transmission link, etc.

Display device 70 presents to an operator two display areas 20 showing characters to be entered and two rigid cursor patterns 40L and 40R which can move within display areas 20. Individual cursors of cursor patterns 40L and 40R are logically associated with finger-activated sensors 63 of the corresponding pointing devices 60L and 60R. Pointing devices 60L and 60R are controlled by operator's hand motions which are detected by movement detection device 65 and used (through operational links 90) to change positions of cursor patterns 40L and 40R within display areas 20, or to change the content displayed within display areas 20. A character from the current content of display area 20 can be entered by activating finger-activated sensor 63 corresponding to the cursor which currently points to that character.

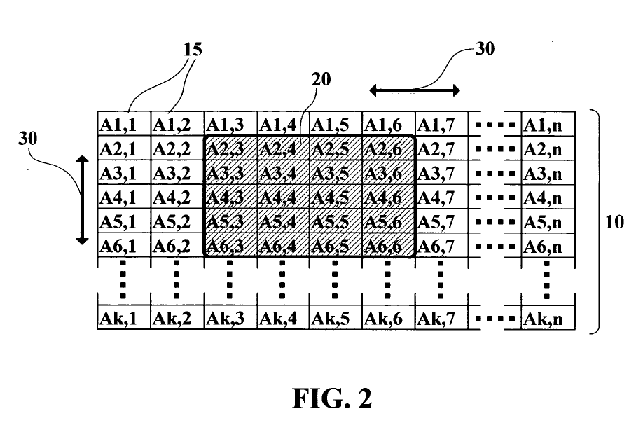

Referring to FIG. 2, the preferred embodiment of the present invention would incorporate an alphabet of characters (letters of the alphabet) 15, logically arranged into a two-dimensional array 10 according to rules allowing convenient localization of characters 15 within array 10 by an operator. A fragment of array 10 is presented to the operator as the content of display area 20. The virtual location of display area 20 within array 10 can be changed so that different contents representing different fragments of array 10 can be presented to the operator. In the preferred embodiment shown in FIG. 2, the virtual location of display area 20 within array 10 can be changed by scrolling along two axes of motion, as indicated by scrolling direction arrows 30.

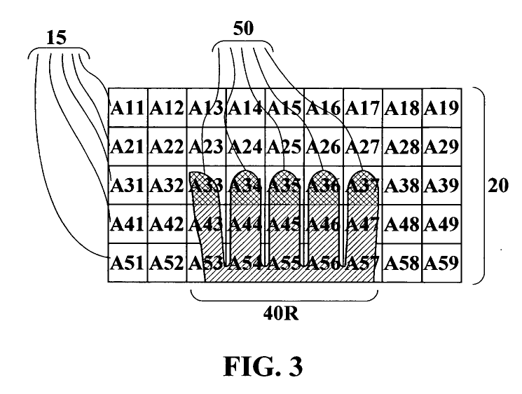

Referring to FIG. 3, cursor pattern 40R located within display area 20 is a configuration of up to five individual cursors 50, logically associated with their corresponding finger-activated sensors 63. Cursor pattern 40R comprising cursors 50 has a predefined fixed shape conveniently indicating how individual fingers of a hand can be used to enter individual characters from subset of characters 15 that are currently presented within display area 20. In FIG. 3, cursor pattern 40R consists of five cursors 50, indicating how to use one of five fingers of operator's right hand to enter one of five characters 15 currently available for entering. A mirror reflection of cursor pattern 40R shown in FIG. 3 would be used for operator's left hand and is shown in FIG. 1 as cursor pattern 40L. Motions of pointing device 60R, detected by movement detection device 65, would change the location of cursor pattern 40R within display area 20. If cursor pattern 40R is moved to an edge of display area 20, any further motion of pointing device 60R in the same direction would scroll the content of display area 20 by changing the virtual location of display area 20 within array 10, as indicated by scrolling direction arrows 30 in FIG. 2.

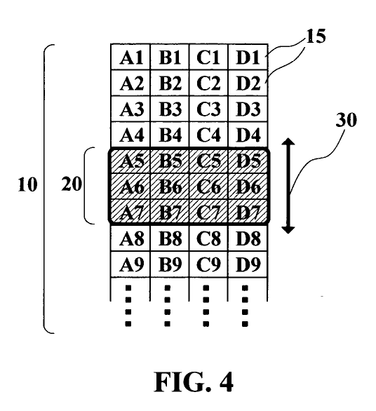

### DESCRIPTION—ALTERNATIVE EMBODIMENTS—FIGS. 4 TO 8

Referring to FIG. 4, in an alternative embodiment of the present invention, two-dimensional array 10 of characters 15 is logically arranged so that display area 20 has the same width as array 10. Therefore, the virtual location of display area 20 within array 10 can be changed by scrolling along only one axis of motion as indicated by scrolling direction arrow 30 in FIG. 4.

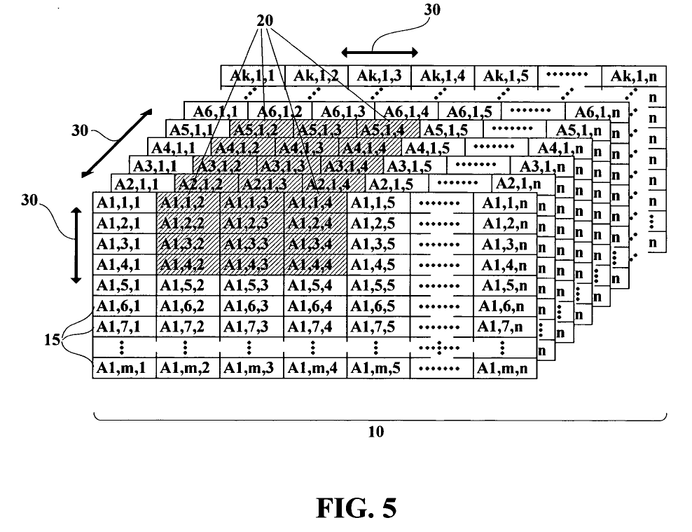

Referring to FIG. 5, in another alternative embodiment of the present invention, the alphabet of characters 15 is logically arranged into a three-dimensional array of characters 10 according to rules allowing convenient localization of characters 15 within array 10 by an operator. In this alternative embodiment of the invention, display area 20 has a three-dimensional structure and it would be presented to the operator by means of holographic imaging or any other display method allowing three-dimensional visualization. In this alternative embodiment of the invention, the virtual location of display area 20 within array 10 can be changed by scrolling along three axes of motion as indicated by scrolling direction arrows 30 in FIG. 5.

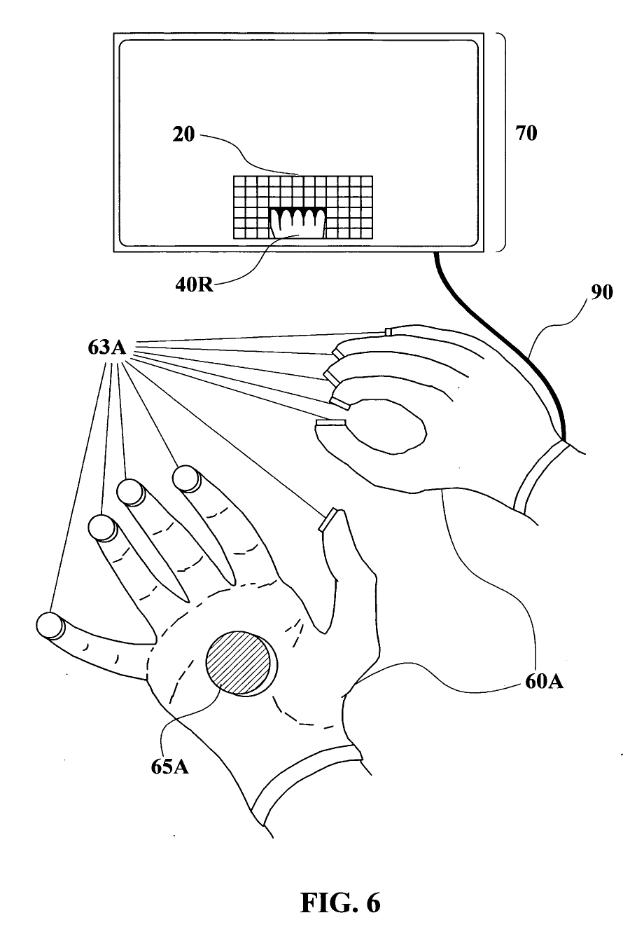

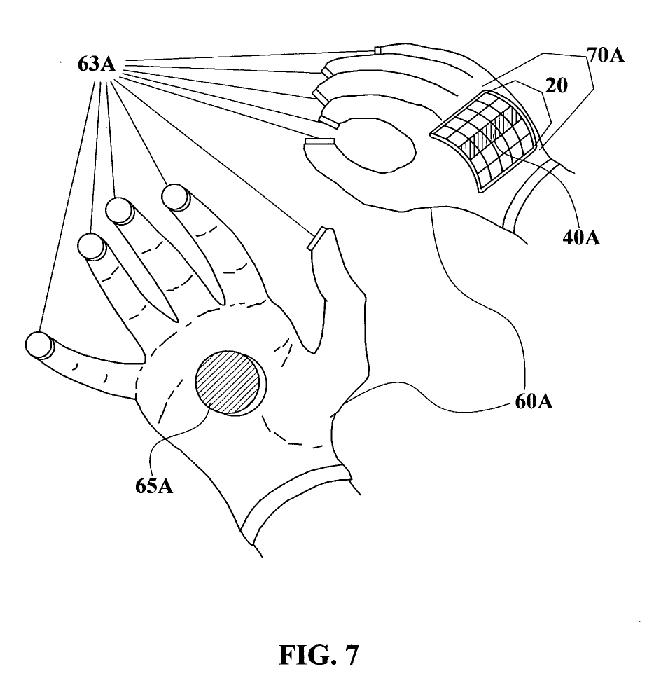

Referring to FIGS. 6 and 7 (each figure showing two views of a right hand), two other alternative embodiments of the present invention are presented wherein a pointing device 60A has the shape of a glove incorporating five finger-activated sensors 63A located at the fingertips, and a movement detection device 65A located in the palm of a hand. In the alternative embodiment shown in FIG. 6, pointing device 60A shaped as a glove is operationally connected (using operational link 90) to display area 20 located within display device 70, which can be any typical display device conveniently presented to the operator. In the alternative embodiment shown in FIG. 7, a display device 70A (with display area 20 occupying most of display device 70A) is located at the back of the glove being pointing device 60A, and operational link 90 (not shown) is incorporated into the glove. A motion of the hand wearing the glove against external objects is detected by movement detection device 65A and results in the corresponding changes of the position of cursor pattern 40A within display area 20, or in the corresponding scrolling of the content of display area 20. Characters currently pointed at by cursors 50 of cursor pattern 40A are entered by pressing the corresponding fingers against external objects, i.e. by activating the corresponding finger-activated sensors 63A.

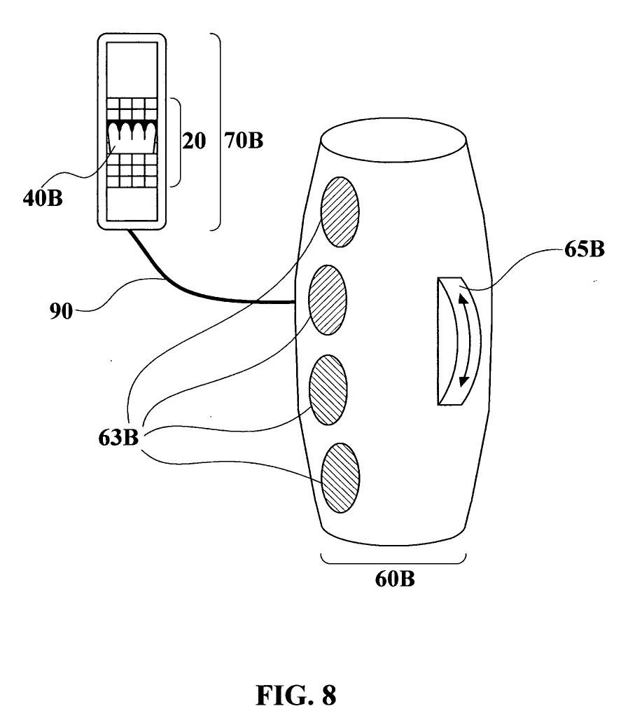

Referring to FIG. 8, yet another alternative embodiment of the present invention is presented in the shape of a hand-held portable pointing device 60B incorporating four finger-activated sensors 63B controlled by fingers, and a movement detection device 65B controlled by a thumb. Movement detection device 65B shown in FIG. 8 is a thumbwheel, but other similar device such as a trackball can also be used. Display area 20 (located within a display device 70B) is operationally connected to pointing device 60B using operational link 90. A motion of the thumb is detected by a movement detection device 65B and results in the corresponding changes of the position of a rigid cursor pattern 40B (with four individual cursors 50) within display area 20, or in the corresponding scrolling of the content of display area 20. Characters currently pointed at by cursors 50 of cursor pattern 40B are entered by pressing any of the four finger-activated sensors 63B by the corresponding fingers. Two-dimensional array 10 has a width of four characters, so that the virtual location of display area 20 within array 10 can be changed by scrolling along only one axis of motion, as indicated by scrolling direction arrow 30 in FIG. 4.

### CONCLUSION, RAMIFICATIONS AND SCOPE

The invention disclosed herein constitutes a versatile, efficient and ergonomic method of inputting data to electronic devices which combines the functions of a keyboard and a pointing device. It is versatile because unlike the conventional keyboard it relies on unlabelled keys—the assignment of characters to keys is software-controlled and therefore the method is suitable for use with any alphabet and can be quickly reconfigured for another alphabet. It is ergonomic as it eliminates the need for an operator to move fingers between keys and to look alternatively at the display and at the keys. It is efficient by utilizing all the fingers of operator's hand or hands.

The present invention can overcome the current problem with using non-Latin alphabets which have hundreds or even thousands of characters. The large number of characters can be arranged in multi-level tables accessible by scrolling. The initial selection of a table with a particular subset of characters can be done with one hand while the selection of a particular character with the other hand.

Another potential application of the present invention is character input to mobile computing and communication devices like mobile phones, PDAs (personal digital assistants), palmtop computers, etc. In such cases, it would be recommended to apply one-hand embodiment with the motion of the cursor pattern and one-dimensional scrolling controlled by a thumb.

In addition to application as an input device for computers, the present invention can be applied to all other electronic devices that require character input. These could include, for example, information terminals, ATMs (Automatic Teller Machines), various ticketing machines as well as game consoles.

Although the present invention has been described and illustrated in detail in the exemplary embodiments, it is clearly understood that the same is by way of illustration and example only and is not to be taken by way of limitation, the spirit and scope of the present invention being limited only by the terms of the appended claims.

What is claimed is:

1. A system apparatus for manually inputting data into computers or other electronic devices comprising:
a) a display device capable of displaying to an operator a subset of characters of a given alphabet,
b) said display device further capable of displaying to the operator two rigid cursor patterns each comprising a plurality of cursors,
c) two pointing devices operationally connected to said display device, said pointing devices controlled by the operator with the purpose to position one of said cursors over the character to be input,
d) said pointing devices each equipped with a plurality of up to five finger-activated sensors operationally connected to said display device, said sensors being permanently assigned to fingers of operator's left and right hands,
whereby the operator can input a character by activating the finger-activated sensor corresponding to the cursor positioned over said character while looking only at said display device.

2. A system apparatus of claim 1 wherein said pointing devices are controlled by an operator using hand motions which are detected by movement detecting means.

3. A system apparatus of claim 1 wherein said pointing devices are controlled by an operator using thumb motions which are detected by movement detecting means.

4. A system apparatus of claim 1 wherein said subset of characters is presented to an operator it two display areas within said display device.

5. A system apparatus of claim 4 wherein content of said display areas can be changed by scrolling using said pointing devices.

6. A system apparatus of claim 1 wherein said subset of characters is presented to an operator in one display area within said display device.

7. A system apparatus of claim 6 wherein content of said display area can be changed by scrolling using said pointing devices.

8. A system apparatus for manually inputting data into computers, mobile phones or other electronic devices comprising:
a) a display device capable of displaying to an operator a subset of characters of a given alphabet in a display area,
b) said display device further capable of displaying to the operator a rigid cursor pattern comprising a plurality of cursors,
c) a pointing device operationally connected to said display device, said pointing device controlled by the operator with the purpose to position one of said cursors over the character to be input,
d) said pointing device equipped with a plurality of up to five finger-activated sensors operationally connected to said display device, said sensors being permanently assigned to fingers of operator's hand,
whereby the operator can input a character by activating the finger-activated sensor corresponding to the cursor positioned over said character while looking only at said display device.

9. A system apparatus of claim 8 wherein said pointing device is controlled by an operator using hand motions which are detected by movement detecting means.

10. A system apparatus of claim 8 wherein said pointing device is controlled by an operator using thumb motions which are detected by movement detecting means.

11. A system apparatus of claim 8 wherein a content of said display area can be changed by scrolling using said pointing device.

12. A method of manually inputting data into computers or other electronic devices comprising:
a) displaying to an operator a subset of characters of a given alphabet in up to two display areas,
b) providing the operator with two clusters of up to five finger-activated sensors, said sensors being permanently assigned to fingers of operator's left and right hand,
c) displaying to the operator two rigid cursor patterns comprising up to five cursors, with each of said cursors representing one of said finger-activated sensors,
d) further providing the operator with two means of controlling position of said rigid cursor patterns,
e) having the operator select characters from said alphabet by first positioning one of said cursors in the display area over the character to be input and then activating the finger-activated sensor corresponding to the cursor positioned over said character.

13. A method of claim 12 wherein content of said display areas can be changed by scrolling using said means of controlling position of said rigid cursor patterns.

14. A method of manually inputting data into computers, mobile phones or other electronic devices comprising:
a) displaying to an operator a subset of characters of a given alphabet, arranged in an array in a display area,
b) providing the operator with a cluster of up to five finger-activated sensors, said sensors being permanently assigned to fingers of operator's hand,
c) displaying to the operator a rigid cursor pattern comprising up to five cursors, with each of said cursors representing one of said finger-activated sensors,
d) further providing the operator with a means of controlling position of said rigid cursor pattern,
e) having the operator select characters from said alphabet by first positioning one of said cursors in said display area over the character to be input and then activating the finger-activated sensor corresponding to the cursor positioned over said character.

15. A method of claim 14 wherein content of said display area can be changed by scrolling using said means of controlling position of said rigid cursor pattern.
